(19) United States
(12) Patent Application Publication
(10) Pub. No.: US 2005/0201504 A1
(43) Pub. Date: Sep. 15, 2005

(54) Apparatus for generating 18F-Fluoride by ion beams

(76) Inventors: Stefan K. Zeisler, Vancouver (CA); Kenneth R. Buckley, Vancouver (CA); Thomas J. Ruth, Vancouver (CA)

Correspondence Address: HARNESS, DICKEY & PIERCE, P.L.C., P.O. BOX 8910, RESTON, VA, 20195, US

(21) Appl. No.: 11/000,040

(22) Filed: Dec. 1, 2004

Related U.S. Application Data
(62) Division of application No. 10/156,113, filed on May 29, 2002.
(60) Provisional application No. 60/297,436, filed on Jun. 13, 2001.

(51) Int. Cl. G21G 1/00

(52) U.S. Cl. 376/156

(57) ABSTRACT

An apparatus for producing ¹⁸F-Fluoride by using a particle beam to irradiate conversion medium in gaseous or liquid form. The irradiated conversion medium is contained in a chamber surrounded by a Fluoride adsorbing material to which the produced ¹⁸F-Fluoride adheres. The adsorption properties of the Fluoride adsorbing material are manipulated by an adsorption enhancing/decreasing element. A solvent dissolves the produced ¹⁸F-Fluoride off of the Fluoride adsorbing material while it is in the chamber. The solvent is then processed to obtain the ¹⁸F-Fluoride.

### CROSS REFERENCE TO RELATED APPLICATION

This application is a divisional application of U.S. patent application Ser. No. 10/156,113, filed on May 29, 2002, which claims priority under 35 U.S.C. §119 (e) of U.S. provisional application 60/297,436, filed Jun. 13, 2001, the entire contents of which are specifically incorporated herein by reference.

### FIELD OF THE INVENTION

The present invention relates to a technique for producing ¹⁸F-Fluoride from ¹⁸O gas, ¹⁶O gas, ²⁰Ne, and/or compounds containing ¹⁸O gas, ¹⁶O gas, ²⁰Ne, such as ¹⁸O-enriched water.

### BACKGROUND OF THE INVENTION

Radiation sources of short half-lives can be used for imaging biological systems if the biological systems can absorb the non-poisonous versions of the sources. Radiation sources with short half lives, such as ¹⁸F-Fluoride, are needed to avoid radiation damage but must last long enough to make the imaging practical.

¹⁸F-Fluoride has a half-life of about 109.8 minutes and is not chemically poisonous in tracer quantities. Fluoro-deoxyglucose (FDG) is an example of a radiation tracer compound incorporating ¹⁸F-Fluoride. In addition to FDG, compounds suitable for labeling with ¹⁸F-Fluoride include, but are not limited to, Fluoro-thymidine (FLT), fluoro analogs of fatty acids, fluoro analogs of hormones, linking agents for labeling peptides, DNA, oligo-nucleotides, proteins, and amino acids. ¹⁸F has, therefore, many uses in forming medical and radiopharmaceutical products. One use is as a radiation tracer compound for medical Positron Emission Tomography (PET) imaging.

The isotope ¹⁸F-Fluoride can be created by irradiation of targets by nuclear beams (e.g., protons, deuterons, alpha particles, . . . ,etc). ¹⁸F-Fluoride forming nuclear reactions include, but are not limited to, ²⁰Ne(d,α)¹⁸F (a notation representing ²⁰Ne adsorbing a deuteron resulting in ¹⁸F and an emitted alpha particle), ¹⁶O(α, pn)¹⁸F,¹⁶O(³H,n)¹⁸F ¹⁶O(³He,p)¹⁸F, and ¹⁸O(p n)¹⁸F; with the greatest yield of ¹⁸F production being obtained by the ¹⁸O(p,n)¹⁸F reaction because it has the largest cross-section. Several elements and compounds (including Neon, water, and Oxygen) are used as the initial material in obtaining ¹⁸F-Fluoride through nuclear reactions.

Technical and economic considerations are critical factors in choosing an ¹⁸F-Fluoride producing system. Because the half-life of ¹⁸F-Fluoride is about 109.8 minutes, quantity production is time dependent. Thus, ¹⁸F-Fluoride producers prefer nuclear reactions that have a high cross-section (i.e., having high efficiency of isotope production) to quickly produce large quantities of ¹⁸F-Fluoride. Additionally, users of ¹⁸F-Fluoride prefer to have an ¹⁸F-Fluoride producing facility near their facilities so as to avoid losing a significant fraction of the produced isotope during transportation. Production efficiency and rate are also a function of the energy and the current of the nuclear beam used for production.

One type of nuclear beam is the proton beam. Systems that produce proton beams are less complex, as well as simpler to operate and maintain, than systems that produce other types of beams. Technical and economic considerations, therefore, drive users to prefer ¹⁸F-Fluoride producing systems that use proton beams and that use as much of the power output available in the proton beams.

Economic considerations also drive users to efficiently use and conserve the expensive startup compounds.

However, inherent characteristics of ¹⁸F-Fluoride and the technical difficulties in implementing ¹⁸F-Fluoride production systems have hindered reducing the cost of preparing ¹⁸F-Fluoride. Existing approaches that use Neon as the startup material suffer from problems of inherent low nuclear reaction yield and complexity of the irradiation facility. The yield from Neon reactions is about half the yield from ¹⁸O(p,n)¹⁸F. Moreover, using Neon as the startup material requires facilities that produce deuteron beams, which are more complex than facilities that produce proton beams. Using Neon as the start-up material, therefore, has resulted in low ¹⁸F-Fluoride production yield at a high cost.

Existing approaches that use ¹⁸O-enriched water (hereinafter ¹⁸water) as the startup material suffer from problems of recovery of the unused ¹⁸O-enriched water and of the limited beam intensity (energy and current) handling capability of water. Recovering the unused ¹⁸O-enriched water is problematic, moreover, because of contaminating by-products generated as a result of the irradiation and chemical processing. This problem has led users to distill the water before reuse and, thus, implement complex distilling devices. These recovery problems complicate the system, and the production procedures, used in ¹⁸O-enriched water based ¹⁸F-Fluoride generation; the recovery problems also lower the product yield due in part to non-productive startup material loss and isotopic dilution.

Moreover, although proton beam currents of over 100 microamperes are presently available, ¹⁸O-enriched water based systems are not reliable when the proton beam current is greater than about 50 microamperes because water begins to vaporize and cavitate as the proton beam current is increased. The cavitation and vaporization of water interferes with the nuclear reaction, thus limiting the range of useful proton beam currents available to produce ¹⁸F-Fluoride from water. See, e.g., Heselius, Schlyer, and Wolf, Appl. Radiat. Isot. Vol. 40, No. 8, pp 663-669 (1989). Systems implementing approaches using ¹⁸O-enriched water to produce ¹⁸F-Fluoride are complex and difficult. For example, recent publications (see, e.g., Helmeke, Harms, and Knapp, Appl. Radiat. Isot. 54, pp 753-759 (2001), (hereinafter “Helmeke”) show that it is necessary to use a complicated proton beam sweeping mechanism, accompanied by the need to have bigger target windows, to increase the beam current handling capability of an ¹⁸O-enriched water system to 30 microamperes. In spite of the complicated irradiation system and target designs, the Helmeke approach has apparently allowed operation for only 1 hour a day. Most producers of large quantities of ¹⁸F-fluoride use water targets with overpressure to retard boiling, and operate in the 40-50 microamperes range and are able to produce 1-3 Curies. Using water as the startup material, therefore, has also resulted in low ¹⁸F-Fluoride production yield at high cost.

Target systems are critical in determining the efficiency and productivity of ¹⁸F-Fluoride production. A well-designed target system can allow the efficient use of ¹⁸water and ¹⁸Oxygen. ¹⁸F-Fluoride can react with the internal surfaces of the target material reducing the extracted yield of reactive Fluoride. For example, titanium is virtually inert but difficult to cool at high beam currents (titanium targets generate ⁴⁸V) and silver forms colloids that can trap ¹⁸F-Fluoride (silver targets form ¹⁰⁹Cd). The use of Niobium produces low concentrations of ^{93m}Mo (T_{1/2}=6.9 h) as a contaminant. All these metals can be removed via the ion column trapping. A target material will need to have such properties that the removal of the ¹⁸F-Fluoride accumulation on the target is unobstructed. Therefore, important considerations for successful target design include the startup material, the adsorbing target material, the layer size of the startup material exposed to the nuclear beam, the selection of chamber materials and cooling of the chamber. Glassy carbon and glassy quartz have many desirable and similar characteristics for adsorbing material. Glassy carbon is temperature resistant, inert to corrosive media, and ¹⁸F-Fluoride can be removed more readily from glassy carbon than from regular glassware. Glassy carbon must be cooled since rapid oxidation of glassy carbon occurs above 500° C.

Accordingly, a better, more efficient, and less costly target system and method for producing ¹⁸F-Fluoride is needed.

### SUMMARY OF THE INVENTION

The invention presents an approach that produces ¹⁸F-Fluoride by using a proton beam to irradiate ¹⁸Oxygen or ¹⁸water (H₂¹⁸O) in gaseous, liquid or steam form. The irradiated ¹⁸Oxygen or ¹⁸water are contained in a chamber that includes at least one accumulation component to which the produced ¹⁸F-Fluoride adheres. A solvent dissolves the produced ¹⁸F-Fluoride off of the at least one component while it is in the chamber. The solvent is then processed to obtain the ¹⁸F-Fluoride.

The inventive approach has an advantage of obtaining ¹⁸F-Fluoride by using a proton beam to irradiate ¹⁸Oxygen or ¹⁸water in gaseous, liquid or steam form. The yield from the inventive approach is high when using ¹⁸Oxygen because the nuclear reaction producing ¹⁸F-Fluoride from ¹⁸Oxygen has a relatively high cross section. The inventive approach also has an advantage of allowing the conservation of the unused ¹⁸Oxygen and its recycled use. The inventive approach is not limited by the presently available proton beam currents (of existing PET cyclotrons); the inventive approach is working at beam currents well over 100 microamperes for ¹⁸Oxygen. The inventive approach, therefore, permits using higher proton beam currents and, thus, further increases the ¹⁸F-Fluoride production yield. The inventive approach has a further advantage of producing pure ¹⁸F-Fluoride, without the other non-radioactive Fluorine isotopes (e.g., ¹⁹F). The inventive approach also has the advantage of using ¹⁸water at lower proton beam currents. The inventive approach reduces the adherency of ¹⁸F-Fluoride to the accumulation component by using voltage differences and/or by heating the accumulation component during ¹⁸F-Fluoride extraction, thus, increasing the ¹⁸F-Fluoride production yield. The inventive approach allows cooling of the accumulation component reducing the oxidation and allowing the use of non-reactive materials such as glassy carbon.

### BRIEF DESCRIPTION OF THE DRAWINGS

Other aspects and advantages of the present invention will become apparent upon reading the detailed description and accompanying drawings given hereinbelow, which are given by way of illustration only, and which are thus not limitative of the present invention, wherein:

FIG. 1 is a cross-section view of an ¹⁸F generating apparatus illustrating an exemplary embodiment of a system according to the present invention; and

FIG. 2 is a general flow chart illustrating a method of using the embodiment of FIG. 1 to produce ¹⁸F-Fluoride from ¹⁸Oxygen gas or ¹⁸water.

### DETAILED DESCRIPTION OF THE PREFERRED EMBODIMENTS

The invention presents an approach that produces ¹⁸F-Fluoride by using a proton beam to irradiate ¹⁸Oxygen or ¹⁸water (H₂¹⁸O) in gaseous, liquid or steam form. The irradiated ¹⁸Oxygen or ¹⁸water is contained in a chamber that includes at least one accumulation component to which the produced ¹⁸F-Fluoride adheres. A solvent dissolves the produced ¹⁸F-Fluoride off of the at least one component while it is in the chamber. The solvent is then processed to obtain the ¹⁸F-Fluoride.

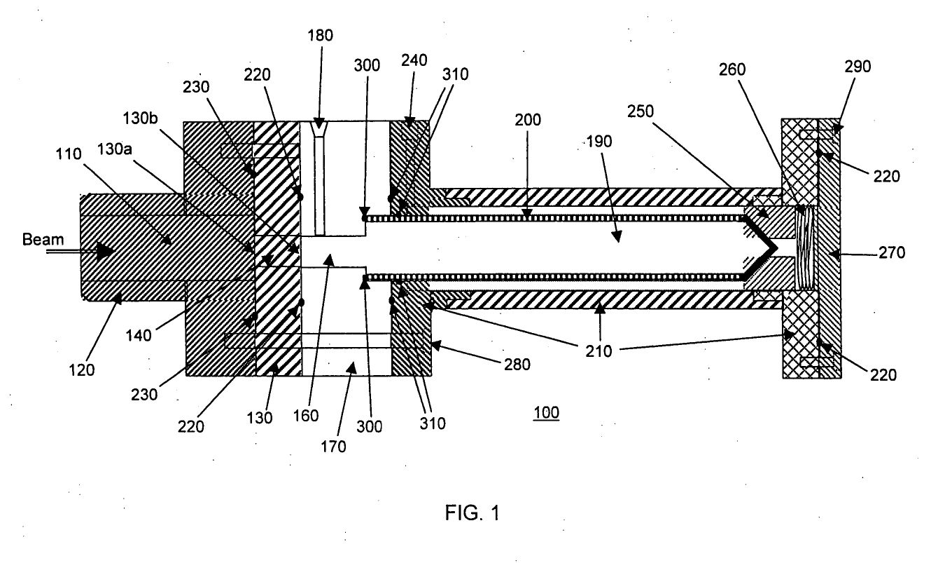

FIG. 1 is a diagram illustrating an exemplary embodiment of a system according to the inventive concept. As shown, an ion beam enters the ¹⁸F-Fluoride generating system 100 through a region 110 of connecting tube 120, connecting tube 120 being connected to block 130. Block 130 contains two foils 130a and 130b at either end of the block 130 aperture defining a region 140. Region 140 may contain a coolant medium which enters and exits the region through an inlet and an outlet respectively (not shown). The beam traverses through region 140 into a region 160 within a flange 170. The flange 170 has at least one inlet 180 to introduce a conversion medium (e.g., ¹⁸Oxygen, and ¹⁸water) and/or the cleaning/removing agent into the second region 160 and the target chamber (chamber) 190. A Fluoride-18 adsorbing (adhering) material 200 (e.g., glassy carbon) forms the target chamber 190 and is cooled by coolant flowing in a cooling jacket 210 which surrounds the adsorbing material 200. The flange 170, block 130, and the connecting tube 120 are sealed with o-rings 220, 230, 300, and 310.

In the embodiment of FIG. 1, the connecting tube 120 conducts an ion beam from an accelerator (not shown) to the target chamber 190. In one implementation the connecting tube is made of Aluminum. Alternative implementations for the material of the connecting tube 120 include, but are not limited to, tungsten, tantalum, or carbon. Preferably the characteristics of the material used to make the connecting tube 120 is neither transparent to the beam, nor rendered radioactive by it; thus keeping the beam from contaminating the environment outside the target chamber and aiding to keep the beam profile constant. In one implementation, the connecting tube 120 has an inside diameter 1 cm, but generally the inside diameter of the connecting tube depends on the diameter of the ion beam directed toward the target.

In the embodiment of FIG. 1; the two foils 130a and 130b define a region 140. The foils are used to separate region conditions (e.g., pressures and region mediums). The two foils, 130a and 130b, can be cooled by a coolant medium in region 140, for example an inert gas, allowing thinner foils which disturb the ion beam profile less. Consequently thin foils and materials such as aluminum, and HAVAR® (Cobalt-Nickel alloy) can be used. Since it is not necessary that region 140 be maintained at high pressures with respect to region 110, an aluminum foil can preferably be used between connecting tube 120 and block 130. However, since higher pressures may exist between region 140 and region 160, the foil between block 130 and flange 170 is preferably made of HAVAR® because it has higher mechanical strength and thus withstands, per thickness unit, relatively higher pressures than most other materials suitable for use as a foil. Consequently, a HAVAR® thin foil holds the region 140 pressure yet does not significantly reduce incident ion beam energy or intensity. Alternatively instead of HAVAR® other suitable materials can be used as the foils 130a and 130b.

In the embodiment of FIG. 1, flange 170 is preferably connected to block 130 and the adsorbing material 200. Flange 170 preferably has at least one inlet 180 to introduce the ¹⁸Oxygen or ¹⁸water into the volume surrounded by the adsorbing material 200. Inlet 180 is also preferably used to introduce the cleaning/removing agent (e.g., water), which removes the Fluoride-18 adhered to the adsorbing material 200, after ion beam irradiation is stopped. In alternate implementations, plural inlets 180 are used to introduce the ¹⁸Oxygen or the ¹⁸water and/or the cleaning/removing agent into the target chamber 190, or to take any or all of them out of the target chamber 190. The material chosen as forming flange 170 is preferably not reactive with Fluoride. In one implementation, stainless steel is used HAVAR® is preferable as the material forming the flange 170. In alternative implementations, niobium or molybdenum is used as the material forming flange 170.

In the embodiment of FIG. 1, in an implementation, a cooling jacket 210 is used to cool the Fluoride-18 adsorbing material 200 during exposure to the ion beam; the cooling jacket in this implementation enclosing a space between itself and the Fluoride-18 adsorbing material 200. Preferably, the cooling jacket 210 has at least one inlet 240 that allows the circulation of the cooling material in the space between the cooling jacket 210 and the Fluoride-18 adsorbing material 200. In another implementation, the cooling jacket 210 has two inlets 240, one inlet for introducing the cooling fluid and the other inlet for taking out the cooling fluid; the cooling fluid thus being able to circulate between the cooling jacket 210 and the Fluoride-18 adsorbing material 200.

In an implementation, aluminum is used as the material forming the cooling jacket 210. In another non-limiting implementation, stainless steel is used as the material forming the cooling jacket 210. In a implementation, the cooling jacket 210 is made of several pieces that are attached together. In another implementation, the cooling jacket is made of one piece.

In an alternative implementation, the cooling jacket 210 is designed to come in direct contact with the Fluoride-18 adsorbing material 200, the jacket completely including a cooling device (e.g., water as circulating cooling fluid). In this implementation, the cooling device cools the cooling jacket 210, which in turn cools the coolant in the cooling jacket 210, which in turn cools the Fluoride-18 adsorbing material 200 by contact.

In an implementation, the cooling jacket 210 is used to heat the material 200 during exposure to the cleaning/removing agent, and thus aids in removing the Fluoride-18 adhered to the adsorbing material 200 by heating the material 200.

The temperature of the various parts of the target chamber 190 can preferably be monitored by, for example, thermocouple(s) (not shown in FIG. 1). Using a cooling jacket allows the cooling of the chamber at various stages of producing ¹⁸F-Fluoride. Heating tapes (not shown) may be used independently of the cooling jacket to heat the chamber or the cooling jacket may be used itself as a heating system by circulating heated fluid. Using heating tapes and/or a heating jacket allows the heating of the chamber at the various stages of producing ¹⁸F-Fluoride. The cooling jacket, the heating tapes, or both, can be used to control the temperature of the chamber 190. Instead of a cooling jacket and heating tapes, other cooling and heating devices can be used. The cooling and heating devices can be located inside or outside the chamber wall (adsorbing material 200). Using temperature-measuring device(s) permits and augments the tracking and automation of the various stages of the ¹⁸F-Fluoride production.

In the embodiment of FIG. 1, in an implementation, the Fluoride adsorbing material 200 has a separate heating jacket (not shown) that heats the material 200 during exposure to the cleaning/removing agent. In one exemplary implementation, heating wire/tape (or wires) is used to heat the adsorbing material 200 and thus aid in removing the Fluoride-18 adhered to the adsorbing material 200. In an implementation, the heating jacket is in direct contact with adsorbing material 200. In an alternate implementation, the heating jacket is in contact with the cooling jacket 210 (but not in contact with the adsorbing material 200) and effectively heats the material 200 by heating the cooling jacket 210.

In an implementation, the Fluoride adsorbing material 200 is connected to an electrical potential source (not shown in FIG. 1) that charges the material 200 with electric charges. In this implementation, preferably care is taken to preserve the electrical integrity of the system by proper insulation so that the system elements, the environment, and personal are protected from exposure to undesired electrical charges. The electrical potential source allows charging the adsorbing material 200 by an electrical potential that has an opposite sign to the charge of the Fluoride-18 ion during exposure to the ion beam, thus aiding through electrical charge attraction the adsorption of the formed Fluoride-18 ions to the surface of the adsorbing material 200. On the other hand, during exposure to the cleaning/removing agent, the charging system can be used so as to charge the adsorbing material 200 to an electrical potential having the same sign of the Fluoride-18 ion, thus aiding through electrical charge repulsion the desorption of the formed Fluoride-18 ions from the adsorption material 200.

In the embodiment of FIG. 1, the Fluoride-18 adsorbing material 200 is, preferably, mechanically supported and aligned with respect to the connecting tube 120 by an alignment block 250, a washer/spring 260 and an end block 270. The alignment block 250 is preferably implemented using aluminum, copper, or VESPEL® (a form of plastic), or other suitable radiation-hard material. The washer/spring 260 is preferably implemented using Belleville Washer(s) and end block 270 is preferably implemented using aluminum. Preferably, the various components of the target system are held together using screws (e.g., 280 and 290) or other mechanical (or chemical, e.g., glue) tools for holding materials together. Preferably, O-rings (300, 220; 230, and 310; preferably implemented as polyether/rubber or other malleable material including metals) are used where appropriate to allow for mechanical flexibility (e.g., expansion due to heating and/or high pressures; contraction during cooling and/or low pressure; and vibration) and to protect non-leaking integrity.

In the embodiment of FIG. 1, in an implementation, glassy carbon is used as the material forming the Fluoride-18 adsorbing material 200. For example, glassy carbon (as SIGRADUR®) obtained from Sigri Corporation in Bedminster, N.J., can be used as the Fluoride adsorbing material 200. In an implementation, the glassy carbon material is in contact with the cooling jacket, or the heating jacket, or both. In another implementation, the glassy carbon is in contact with a highly thermally conducting substrate (e.g., a layer of synthetic diamond or other appropriate material such as a metal or metallic alloy) which is then operatively in contact with the cooling and/or cooling jacket(s).

In another implementation, glassy quartz is used as the material forming the Fluoride-18 adsorbing material 200. In an implementation the glassy quartz material is in contact with the cooling/heating jackets. In another implementation, the glassy quartz is in contact with a highly thermally conducting substrate (e.g., a layer of carbon as SiC, a layer of synthetic diamond, or other appropriate material such as a metal or metallic alloy), which is then operatively in contact with the cooling and/or cooling jacket(s).

In another implementation, niobium is used as the material forming the Fluoride-18 adsorbing material 200. In an implementation the niobium material is in contact with the cooling jacket, or the heating jacket, or both. In another implementation, the niobium is in contact with a highly thermally conducting substrate (e.g., a layer of synthetic diamond, or other appropriate material such as a metal or metallic alloy) which is then operatively in contact with the cooling and/or cooling jacket(s).

In another implementation, molybdenum is used as the material forming the Fluoride-18 adsorbing material 200. In an implementation the molybdenum material is in contact with the cooling jacket, or the heating jacket, or both. In another implementation, the adsorbing material 200 is composed of a conducting substrate (e.g., a layer of synthetic diamond, or other appropriate material such as a metal or metallic alloy) operatively in contact with the cooling and/or cooling jacket(s), and a layer of molybdenum deposited on the conducting substrate facing the chamber 190.

In another implementation, synthetic diamond is used as the material forming the Fluoride-18 adsorbing material 200. In an implementation the synthetic diamond is in contact with the cooling jacket, or the heating jacket, or both. In another implementation, the adsorbing material 200 is composed of a conducting substrate (e.g., a metal, metallic alloy or other suitable material such as Ag, Stainless Steel (SS), etc.) operatively in contact with the cooling and/or cooling jacket(s), and a layer of synthetic diamond deposited on the conducting substrate facing the chamber 190.

Other materials listed in U.S. patent application Ser. No. 09/790,572 (specifically incorporated in this application by reference) can be used as the Fluoride-18 adsorbing material 200.

In the embodiment of FIG. 1, the target chamber 190, filled with ¹⁸Oxygen gas as the material being irradiated with the ion beam, has a cylindrically shaped volume. In an alternative implementation for using ¹⁸Oxygen gas, the volume of chamber 190 has a conic shape flaring out as one goes away from the connecting tube 120 (as shown in FIG. 1 of the U.S. patent application Ser. No. 09/790,572).

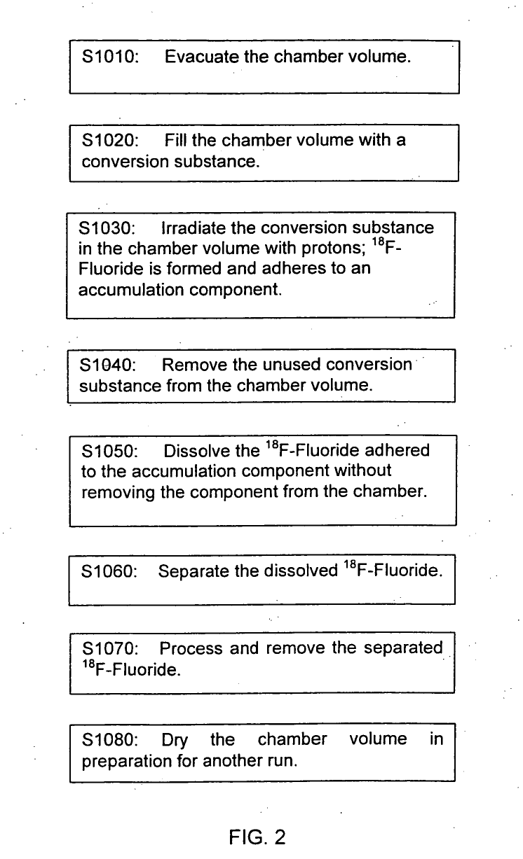

In the embodiment of FIG. 1, an implementation for using ¹⁸water as the material being irradiated with ion beams to produce Fluoride-18, the volume of chamber 190 has a cylindrical shape. In an alternative implementation for using ¹⁸water, volume of chamber 190 has a spherical shape (as in FIG. 2 of the Technical Note “A water-cooled spherical niobium target for the production of [¹⁸F] Fluoride” by S. K. Zeisler, D. W. Becker, R. A. Pavan, R. Moschel, and H. Ruhle; Applied Radiation and Isotopes 53 (2000) 449-453; the Technical Note being explicitly incorporated in this application by reference, in its entirety and for any purpose). In an alternative implementation for using ¹⁸water, the volume of chamber 190 has a conical shape flaring out as one goes away from the connecting tube 120 (as shown in FIG. 1 of the U.S. patent application Ser. No. 09/790,572).

The size of the target chamber 190 and its dimensions depend on the ion beam profile/intensity/energy, the material used (¹⁸Oxygen gas or ¹⁸water), its pressure, its temperature, and the desired output of Fluoride-18. Necessary dimensions (and therefore specifics of the shape of the chamber 190), to allow desired conditions, are preferably calculated using a program called SRIM (Stopping & Range of Ions in Matter; distributed by IBM Research in Yorktown, N.Y., and prepared by James F. Ziegler; the program and its supporting material, existing on or before today, being explicitly incorporated in this application by reference, in its entirety and for any purpose).

It is to be noted that although this disclosure has described a target system for using ¹⁸Oxygen gas or ¹⁸water as the material being irradiated with ions to produce Fluoride-18, the target system described herein can be used for other methods of producing Fluoride-18 including, but not limited to, 20Ne(d,α)¹⁸F (a notation representing a 20Ne adsorbing a deuteron resulting in ¹⁸F and an emitted alpha particle), ¹⁶O(α,pn)¹⁸F,¹⁶O(3H,n)¹⁸F, and ¹⁶O(3He, p)¹⁸F.

A method of implementing the inventive concept is described hereinafter, by reference to FIG. 2, as an exemplary method for using the embodiment of FIG. 1.

In step S1010, the target chamber. 190 is evacuated. This can be accomplished, for example, by opening inlet 180 and exposing the target chamber 190 to a vacuum pump (not shown). The vacuum pump can be implemented, for example, as a mechanical pump, diffusion pump, or both. The desired level of vacuum in target chamber 190 is preferably high enough so that the amount of contaminants is low compared to the amount of ¹⁸F-Fluoride formed per run. Heating the target chamber 190, so as to speed up its pumping, can augment step S1010.

In step S1020, the target chamber 190 is filled with a conversion substance (e.g., ¹⁸Oxygen gas or ¹⁸water) to a desired pressure. This can be accomplished, for example, by opening inlet 180 and allowing the conversion substance to go from a reservoir (not shown) to the target chamber 190. Pressure gauges (not shown) can be used to keep track of the pressure and, thus, the amount of conversion substance in the target chamber.

In step S1030, the conversion substance in target chamber 190 is irradiated with a proton beam. This can be accomplished, for example, by closing inlet 180 and directing the proton beam through regions 110, 140 and 160 respectively into the target chamber 190. The foils separating the target chamber from region 140 can be made of a thin foil material that transmits the proton beam while containing the conversion substance and the formed ¹⁸F-Fluoride. As the proton beam is irradiating the conversion substance, some of the conversion substance nuclei undergo a nuclear reaction and are converted into ¹⁸F-Fluoride. The nuclear reaction that occurs for ¹⁸Oxygen is:
¹⁸Oxygen+p→¹⁸F+n.

The irradiation time can be calculated based on well-known equations relating the desired amount of ¹⁸F-Fluoride; the initial amount of conversion substance present, the proton beam current, the proton beam energy, the reaction cross-section, and the half-life of ¹⁸F-Fluoride. TABLE 1 shows the predicted yields for a proton beam current of 100 microamperes at different proton energies and for different irradiation times using ¹⁸Oxygen gas as the conversion substance.

TABLE 1

| | | TTY with 2-Hour | TTY with 4-Hour |
|---|---|---|---|
| | | Irradiation | Irradiation |
| Ep (MeV) | TTY at Sat (Ci) | (Ci) | (Ci) |
| 12 | 21 | 10.5 | 15.8 |
| 15 | 25 | 12.5 | 18.8 |
| 20 | 30 | 15 | 22.5 |
| 30 | 46 | 23 | 34.5 |

TTY is an abbreviation for thick target yield, wherein the ¹⁸Oxygen gas being irradiated is thick enough—i.e., is at enough pressure—so that the entire transmitted proton beam is absorbed by the ¹⁸Oxygen. The yields are in curie. TTY at Sat is the yield when the irradiation time is long enough for the yield to saturate-about 12 hours for ¹⁸F production, the point where the rate of production equals the rate of radioactive decay.

Preferably the ¹⁸Oxygen gas is at high pressures: The higher the pressure the shorter the necessary length for the target chamber 190 to have the ¹⁸Oxygen gas present a thick target to the proton beam. TABLE 2 shows the stopping power (in units of gm/cm2) of Oxygen for various incident proton energies and ranges of penetration. The length of ¹⁸Oxygen gas (the gas being at a specific temperature and pressure) that is necessary to completely absorb a proton beam at a specific energy is given by the stopping power of Oxygen divided by the density of ¹⁸Oxygen gas (the density being at the specific temperature and pressure). Using this formula, a length of about 156 centimeters of ₁₈Oxygen gas at STP (300K temperature and 1 atm pressure) is necessary to completely absorb a proton beam having energy of 12.0 MeV. By increasing the pressure to 20 atm, the necessary length at 300K becomes about 7.75 centimeters.

TABLE 2

| Proton Energy | Range | Stopping Power for |
|---|---|---|
| MeV | R (mm) | R(gm/cm2) |
| 2 | 71.29 | 0.01019447 |
| 2.25 | 86.63 | 0.01238809 |
| 2.5 | 103.26 | 0.01476618 |
| 2.75 | 121.14 | 0.01732302 |
| 3 | 140.27 | 0.02005861 |
| 3.25 | 160.6 | 0.0229658 |
| 3.5 | 182.14 | 0.02604602 |
| 3.75 | 204.86 | 0.02929498 |
| 4 | 228.75 | 0.03271125 |
| 4.5 | 279.96 | 0.04003428 |
| 5 | 335.7 | 0.0480051 |
| 5.5 | 395.9 | 0.0566137 |
| 6 | 460.49 | 0.06585007 |
| 6.5 | 529.39 | 0.07570277 |
| 7 | 602.56 | 0.08616608 |
| 8 | 761.32 | 0.10886876 |
| 9 | 936.59 | 0.13393237 |
| 10 | 1130 | 0.16159 |
| 11 | 1340 | 0.19162 |
| 12 | 1560 | 0.22308 |
| 13 | 1800 | 0.2574 |
| 14 | 2050 | 0.29315 |
| 15 | 2320 | 0.33176 |
| 16 | 2600 | 0.3718 |
| 17 | 2900 | 0.4147 |
| 18 | 3210 | 0.45903 |
| 20 | 3880 | 0.55484 |
| 22.5 | 4790 | 0.68497 |
| 25 | 5790 | 0.82797 |
| 27.5 | 6870 | 0.98241 |
| 30 | 8040 | 1.14972 |
| 32.5 | 9280 | 1.32704 |
| 35 | 10610 | 1.51723 |
| 37.5 | 12010 | 1.71743 |
| 40 | 13490 | 1.92907 |
| 45 | 16680 | 2.38524 |
| 50 | 20160 | 2.88288 |
| 55 | 23930 | 3.42199 |
| 60 | 27970 | 3.99971 |
| 65 | 32290 | 4.61747 |
| 70 | 36880 | 5.27384 |
| 80 | 46810 | 6.69383 |
| 90 | 57750 | 8.25825 |
| 100 | 69630 | 9.95709 |

Consequently in one implementation, the target chamber 190 (along with its parts) is designed to withstand high pressures, especially since higher pressures become necessary as the target chamber 190 and gas heat up due to the irradiation by the proton beam. In one exemplary implementation of the inventive concept to produce ¹⁸F-Fluoride from ¹⁸Oxygen gas, we have demonstrated the success of using HAVAR® with thickness of 40 micrometers to contain ¹⁸Oxygen at fill pressure of 20 atm irradiated with 13 MeV proton beam (protons with 12.5 MeV transmitting into the chamber volume, 0.5 MeV being absorbed by the HAVAR® chamber window) at a beam current of 20 microamperes. The exemplary implementation successfully contained the ¹⁸Oxygen gas during irradiation with the proton beam and, therefore, with the ¹⁸Oxygen gas having much higher temperatures (well over 100° C.) and pressures than the fill temperature and pressure before the irradiation. In another exemplary implementation, cooling jackets (lines) were used to remove heat from the chamber volume during irradiation. An implementation would run the inventive concept at high pressures to have relatively short chamber length. In alternative implementations, other suitable designs can be used to contain the ¹⁸Oxygen gas at desired pressures.

The ¹⁸F-Fluoride adheres to the adsorbing material 200 as it is performed. Preferably the adsorbing material 200 is chosen to be a material to which ¹⁸F-Fluoride adheres well. Additionally it is preferably one of which the adhered ¹⁸F-Fluoride dissolves easily when exposed to the appropriate solvent. Such materials include, but are not limited to, stainless steel, glassy Carbon, glassy quartz, Titanium, Silver, Gold-Plated metals (such as Nickel), Niobium, HAVAR®, and Nickel-plated Aluminum. Periodic pre-fill treatment of the adsorbing material 200 can be used to enhance the adherence (and/or subsequent dissolving, see later step S1050) of ¹⁸F-Fluoride.

In step 1040, the unused portion of conversion substance is removed from the target chamber 190. This can be accomplished, for example, by opening the inlet 180, inlet 180 being connected to a container (not shown), with the container cooled to below the boiling point of the conversion substance. In this case, the unused portion of conversion substance is drawn into the container and, thus, is available for use in the next run. This step allows for the efficient use of the conversion substance. It is to be noted that the cooling of the container to below the boiling point of conversion substance can be performed as the target chamber 190 is being irradiated during step S1030. Such an implementation of the inventive concept reduces the run time as different steps are performed. The pressure of the conversion substance can be monitored by pressure gauges (not shown).

In step S1050, the formed ¹⁸F-Fluoride adhered to the adsorbing material 200 is preferably dissolved using a solvent without taking the adsorbing material 200 out of the target chamber 190. This can be accomplished, for example, by opening inlet 180 and allowing the solvent to be introduced to the target chamber 190. The adhered ¹⁸F-Fluoride is preferably dissolved by and into the introduced solvent. Heating the target chamber 190 so as to speed up the dissolving of the produced ¹⁸F-Fluoride can augment step S1050. The solvent may be introduced into the target chamber 190 by opening inlet 180 after step 1040. This procedure allows the solvent to be sucked into the vacuum existing in the target chamber 190, thus aiding in introducing the solvent and physically washing the adsorbing material 200. Alternatively, the solvent can also be introduced due to its own flow pressure.

The material used as a solvent, preferably should easily remove (physically and/or chemically) the ¹⁸F-Fluoride adhered to the adsorbing material 200, yet preferably easily allow the uncontaminated separation of the dissolved ¹⁸F-Fluoride. It also preferably should not be corrosive to the system elements with which it comes into contact. Examples of such solvents include, but are not limited to, water in liquid and steam form, acids, and alcohols. ¹⁹Fluorine is preferably not the solvent—the resulting mixture would have ¹⁸F-¹⁹F molecules that are not easily separated and would reduce, therefore, the yield of the produced ultimate ¹⁸F-Fluoride based compound.

TABLE 3 shows the various percentages of the produced ¹⁸F-Fluoride extracted using water at various temperatures. It is seen that an adsorbing component made from Stainless Steel yields 93.2% of the formed ¹⁸F-Fluoride in two washes using water at 80° C. Glassy Carbon, on the other hand, yields 98.3% of the formed ¹⁸F-Fluoride in a single wash with water at 80° C., the wash time was on the order of ten seconds. Using water at higher temperatures is expected to improve the yield per wash. Steam is expected to perform at least as well as water, if not better, in dissolving the formed ¹⁸F-Fluoride. Other solvents may be used instead of water, keeping in mind the objective of rapidly dissolving the formed ¹⁸F-Fluoride and the objective of not diluting the Fluorine based ultimate compound.

TABLE 3

| Material of | % Recovered | % Recovered | Total % | |
|---|---|---|---|---|
| Chamber | in | in | Recovered in | Wash Temp |
| Component | 1^{st} Wash | 2^{nd} Wash | 2 Washes | ° C. |
| Ni-plated Al | 66.4 | 7.4 | 73.8 | 80 |
| Ni-plated Al | 42.9 | 6.8 | 49.7 | 60 |
| Ni-plated Al | 34.4 | 4.4 | 38.8 | 20 |
| Stainless Steel | 80.6 | 12.6 | 93.2 | 80 |
| Aluminum | 5.6 | 1.8 | 7.5 | 80 |
| Glassy Carbon | 64.1 | 22.9 | 87.0 | 20 |
| Glassy Carbon | 98.3 | N.A. | 98.3 | 80 |

In step 1060, the formed ¹⁸F-Fluoride is separated from the solvent, which can be accomplished, for example, by a separator (not shown). The separator separates the formed ¹⁸F-Fluoride from the solvent and retains the formed ¹⁸F-Fluoride.

The separator [not shown] can be implemented using various approaches. One implementation for the separator is to use an ion exchange column that is anion attractive (the formed ¹⁸F-Fluoride being an anion) and that separates the ¹⁸F-Fluoride from the solvent. For example, DOWEX IX-10, 200-400 mesh commercial resin, or Toray TIN-200 commercial resin, can be used as the separator. Yet another implementation is to use a separator having specific strong affinity to the formed ¹⁸F-Fluoride such as a QMA® We Sep-Pak, for example. Such implementations for the separator preferentially separate and retain ¹⁸F-Fluoride but do not retain the radioactive metallic byproducts (which are cations) from the solvent, thus retaining a high purity for the formed radioactive ¹⁸F-Fluoride. Another implementation for the separator is to use a filter retaining the formed ¹⁸F-Fluoride.

In step 1070, the separated ¹⁸F-Fluoride is processed from the separator using methods like those described in the incorporated U.S. patent application Ser. No. 09/790,572, FIG. 2 Step 1070.

After drying the target chamber 190 from solvent remnants, the system is ready for another run for producing a new batch of ¹⁸F-Fluoride. The overall process can then be repeated starting with step S1010.

Demonstration runs of the inventive concept have consistently yielded at least about 70% of the theoretically obtainable ¹⁸F-Fluoride from ¹⁸Ogas. The setup had a chamber volume of about 15 milliliters, the ¹⁸Oxygen gas was filled to about pressure of 20 atmospheres, the proton beam was 13 MeV having beam current of 20 microamperes, the solvent was de-ionized water with volume of 100 milliliters and a QMA® separator was eluted with 2×2 milliliters of Bicarbonate solution. Such a result is especially important because ¹⁸Oxygen in gaseous form has 14-18% better yield than ¹⁸O-enriched water because the Hydrogen ions in the ¹⁸O-enriched water reduce the exposure of the ¹⁸Oxygen to the proton beam. Consequently, the inventive concept produces significantly greater overall yield of ¹⁸F-Fluoride than can be produced by ¹⁸O-enriched water based systems. For example, running a simple (non-sweeping beam) system implementing the inventive concept at a proton current beam of 100 microamperes and energy of 15 MeV will produce about 300% greater overall yield than the complicated (sweeping beam and bigger target window) system of Helmeke running at its apparent maximum of 30 microamperes. Thus, the present invention will increase yield by a factor of three.

The inventive concept can be implemented with a modification using separate chemically inert gas inlets 180, instead of one inlet, to perform various steps in parallel. The target chamber 190, and its different parts, can be formed from various different suitable designs and materials. This can be done to permit increasing the incident proton beam currents, for example.

Although the present invention has been described in considerable detail with reference to certain exemplary embodiments, it should be apparent that various modifications and applications of the present invention may be realized without departing from the scope and spirit of the invention. All such variations and modifications as would be obvious to one skilled in the art are intended to be included within the scope of the claims presented herein.

1. An apparatus used in generating Fluoride-18 comprising:
a material enclosing a chamber volume, wherein said material absorbs Fluoride-18 formed by beam irradiation of a conversion substance; and
an adsorption affecting arrangement, operatively connected to said material, wherein said arrangement affects said material so as to increase or decrease said material's adsorption of Fluoride-18.

2. An apparatus according to claim 1, wherein said material is stainless steel.

3. An apparatus according to claim 1, wherein said material is glassy carbon.

4. An apparatus according to claim 1, wherein said material is glassy quartz.

5. An apparatus according to claim 1, wherein said material is niobium.

6. An apparatus according to claim 1; wherein said material is molybdenum.

7. An apparatus according to claim 1, wherein said material is synthetic diamond.

8. An apparatus according to claim 1, wherein said conversion substance is gaseous 180, or gaseous 160, or a compound containing 180 or 160.

9. An apparatus according to claim 1, wherein said conversion substance is ²⁰Ne, ²¹Ne, ²²Ne, or a compound containing ²⁰Ne, ²¹Ne, or ²²Ne.

10. An apparatus according to claim 1, wherein said arrangement cools said material.

11. An apparatus according to claim 1, wherein said arrangement heats said material.

12. An apparatus according to claim 1, wherein said arrangement provides an electric potential to said material.

13. An apparatus according to claim 4, wherein said arrangement additionally heats and/or cools said material.
